(19) United States
(12) Patent Application Publication
(10) Pub. No.: US 2007/0174868 A1
(43) Pub. Date: Jul. 26, 2007

(54) Apparatus for personal authentication

(75) Inventor: Go Hitaka, Saitama-ken (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, TOKYO (JP)

(21) Appl. No.: 11/384,932

(22) Filed: Mar. 20, 2006

(30) Foreign Application Priority Data
Jan. 26, 2006 (JP) 2006-17242

(51) Int. Cl. H04N 7/16; H04M 1/56; H04M 15/06

(52) U.S. Cl. 725/30; 725/62; 725/25; 379/142.05

(57) ABSTRACT

A communication apparatus for authenticating a plurality of people is provided. The communication apparatus includes an input device for obtaining a first set of data for identifying a first person of the people, a receiver for receiving a second set of data for identifying a second person of the people, and a memory for storing a plurality of data for identifying at least two of the people. The communication apparatus includes a controller coupled to the input device, the receiver and the memory. The controller is configured to limit a particular function of the communication apparatus, to compare each of the first set of data and the second set of data with the stored data, and to stop limiting the particular function upon finding out that one and another of the two people identified by the stored data coincide with the first person and the second person, respectively.

### CROSS REFERENCE TO RELATED APPLICATIONS

This application is based upon and claims the benefit of priority from the prior Japanese Patent Application No. 2006-017242 filed on Jan. 26, 2006; the entire contents of which are incorporated herein by reference.

### FIELD OF THE INVENTION

The present invention relates to apparatus for personal authentication and in particular to a communication apparatus having an authentication capability.

### DESCRIPTION OF THE BACKGROUND

A variety of authentication systems is known which is used in communications for secure on-line trade, for secure payment and so on by electronic money stored, e.g., in a built-in non-contact IC chip of a communication apparatus.

A communication apparatus is known which is configured to obtain an image of a person. The communication apparatus may compare that image with another image of the person stored in advance. The communication apparatus may make a phone call and send a piece of information resulting from the comparison to an opposite end of the call so that the person may be identified at the opposite end.

The opposite end, having a database including a plurality of data regarding the person, may receive the information and retrieve some relevant data out of the database based on the information so that the person may be identified. The above communication apparatus is disclosed in Japanese Patent Publication (Kokai), No. 2004-21748.

A TV call apparatus is known which is configured to have a camera and a database that may include an image of a right person to use the TV call apparatus. During a TV call, the TV call apparatus may compare an image of a person photographed by the camera with the image of the right person. The TV call apparatus accepts a plurality of commands entered by its user in a case where the above two images coincide. The TV call apparatus cancels the entered commands in a case where the above two images do not coincide. The above TV call apparatus is disclosed in Japanese Patent Publication (Kokai), No. 2000-137809.

An image of a person is very often an image of his or her face. A variety of methods of face authentication is known, i.e., extracting some features of a face of a person to be authenticated and comparing them with an image included in a database in terms of those features. Some methods of face authentication are disclosed in a reference listed here: Akamatsu, “Computer recognition of human face-A survey-”, IECEJ Trans. Vol. J80-A, No.8, pp.1215-1230, August 1997.

A user of a communication apparatus having a particular function like having dealings or settling accounts through the Internet, e.g., may require an approval of a supervisor for using the function. In such a case, the supervisor as well as the user should be authenticated to make the use of the function safer.

The above, so called double authentication helps keep the user from overusing the function without the approval from the authenticated supervisor, particularly in a case where the user is a child or a youngster. It is apparent that neither the above communication apparatus nor the above TV call apparatus may be applied to the above double authentication.

### SUMMARY OF THE INVENTION

Accordingly, an advantage of the present invention is that a communication apparatus for personal authentication may be used safely.

To achieve the above advantage, one aspect of the present invention is to provide a communication apparatus capable of authenticating a plurality of people. The communication apparatus includes an input device configured to obtain a first set of data for identifying a first person of the people, a receiver configured to receive a second set of data for identifying a second person of the people, and a memory configured to store a plurality of data for identifying at least two of the people. The communication apparatus also includes a controller configured to limit a particular function of the communication apparatus, to compare the first set of data and the stored data, to compare the second set of data and the stored data, and to stop limiting the particular function upon finding out that one and another of the two people identified by the stored data coincide with the first person and the second person, respectively.

### BRIEF DESCRIPTION OF THE DRAWINGS

FIG. 1 is a conceptual diagram of a network including a communication apparatus of a first embodiment of the present invention.

FIG. 2 shows an external view of the communication apparatus shown in FIG. 1.

FIG. 3 is a block diagram of the communication apparatus shown in FIG. 1.

FIG. 4 is a flow chart of a process of the first embodiment of the present invention.

FIG. 5 is a flow chart of a process of a second embodiment of the present invention.

FIG. 6 is a flow chart of a process of a third embodiment of the present invention.

### DETAILED DESCRIPTION OF THE INVENTION

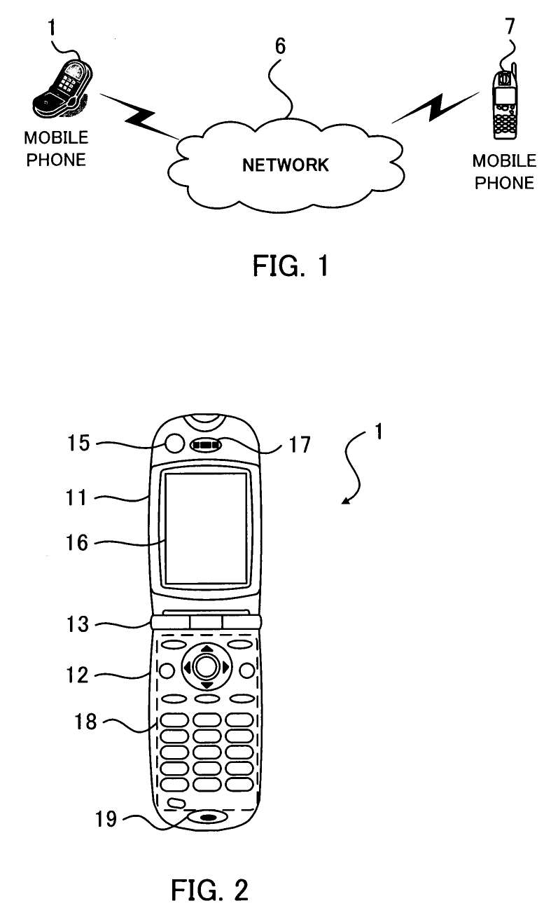

A first embodiment of the present invention will be described with reference to FIGS. 1-4. FIG. 1 is a conceptual diagram of a network including a mobile phone 1, i.e., a communication apparatus of the first embodiment. The mobile phone 1 is connected to a network 6 by sending and receiving radio signals to and from a base station (not shown) included in the network 6.

On the right hand side of FIG. 1, there is shown another mobile phone 7 connected to the network 6 in a similar manner. The mobile phone 1 has a built-in camera, and may be used for a TV call with the mobile phone 7.

The mobile phone 1 has a non-contact type IC chip usable for electronic money (e-money). The mobile phone 1 may limit an operation of the non-contact type IC chip, and may stop limiting the operation if a set of predetermined requirements are satisfied as follows.

Firstly, the mobile phone 1 is required to detect a coincidence between a person at the mobile phone 1 photographed by the camera of the mobile phone 1 and a person of a first category registered in the mobile phone 1, as a result of personal authentication. Secondly, the mobile phone 1 is required to detect another coincidence between a person at the mobile phone 7 and a person of a second category registered in the mobile phone 1, as another result of personal authentication.

The first category is “limited function users”, and no less than one person may be registered in the first category. The second category is “supervisors”, and no less than one person may be registered in the second category.

FIG. 2 shows an external view of the mobile phone 1. The mobile phone 1 has a first case 11 and a second case 12 connected to each other via a connecting portion 13 in such a way that the first case 11 may be flipped over the second case 12.

The first case 11 has a camera 15 and has a display 16 formed by, e.g., a liquid crystal device, and an earpiece 17. The camera 15 may take a static picture. The camera 15 may take a moving picture. The display 16 may present a plurality of letters, numerals, symbols, pictures and a cursor.

The second case 12 has a set of user controls (hereinafter called the user control) 18 in an area enclosed by a dashed line. The user control 18 includes a plurality of numeric keys each of which may toggle a numeral and a few letters and symbols. The user control 18 includes a navigation key usable for moving the cursor up, down, left or right. The user control 18 includes a plurality of soft keys each of which may be assigned a specific function. The second case 12 has a microphone 19.

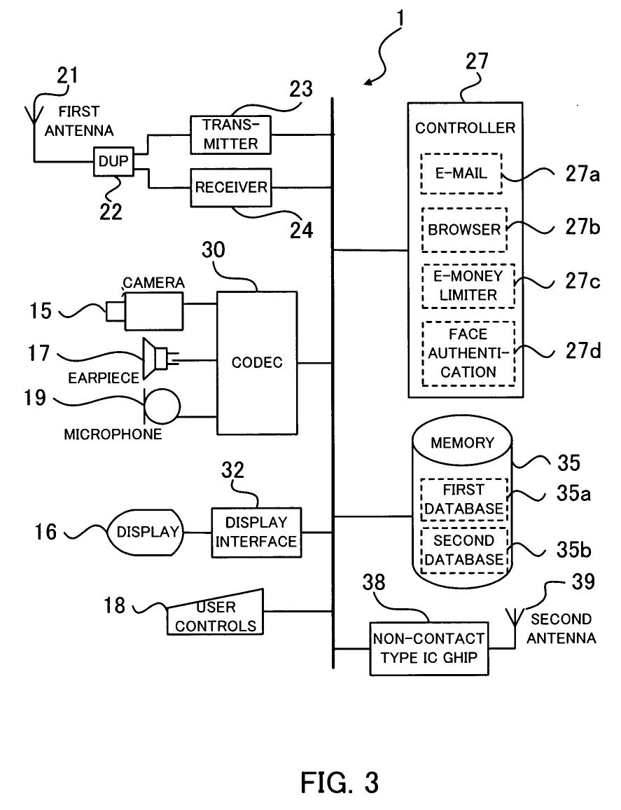

FIG. 3 is a block diagram of the mobile phone 1. There is shown a first antenna 21 on an upper, left hand side of FIG. 3. The first antenna 21 may be used for sending and receiving radio signals to and from the base station included in the network 6. The first antenna 21 is connected to a duplexer 22 and is linked to a transmitter 23 and a receiver 24, respectively, via the duplexer 22.

The transmitter 23 may encode a piece of outgoing information, and may modulate, up-convert and amplify an encoded signal to generate an outgoing radio signal. The transmitter 23 may further emit the outgoing radio signal into the air toward the base station via the duplexer 22 and the first antenna 21.

The receiver 24 may receive an incoming radio signal emitted by the base station via the first antenna 21 and the duplexer 22. The receiver 24 may amplify, down-convert and demodulate the incoming radio signal, and may further decode a demodulated output to extract a piece of incoming information.

An input port of the transmitter 23 and an output port of the receiver 24 are connected to a controller 27, respectively. The controller 27 is formed by, e.g., a processing device like a microprocessor or a digital signal processor. The controller 27 may monitor and control each part and a whole of the mobile phone 1.

The controller 27 may send a plurality of outgoing digital data to the transmitter 23, and may obtain a plurality of incoming digital data carried by a plurality of radio signals received by the receiver 24. In FIG. 3, there are classified a plurality of main processes done by the controller 27 and each of them is shown as a dashed rectangle in the controller 27. Each of those main processes will be explained eight paragraphs later.

The mobile phone 1 has a codec 30 that is connected to the transmitter 23, the receiver 24 and the controller 27. The codec 30 is connected to the camera 15, the earpiece 17 and the microphone 19, each of which has been explained with reference to FIG. 2.

The codec 30 may digitize and encode an analog voice signal picked up by the microphone 19, and may send a plurality of encoded digital voice data to the transmitter 23. The codec 30 may obtain and decode a plurality of digital voice data carried by the radio signals received by the receiver 24 to convert into an analog form, and may drive the earpiece 17 with a resultant analog voice signal. The codec 30 may encode an image signal of a picture photographed by the camera 15, and may send a plurality of encoded image data to the controller 27. The controller 27 may send a plurality of image data and a plurality of text data to the display 16 via a display interface 32.

The user control 18, earlier explained with reference to FIG. 2, is connected to the controller 27 and may send information on which numeral, letter or symbol has been entered by being operated. The user control 18 may be operated to make a TV call, and may be operated to end a TV call. The user control 18 may be operated to perform face authentication of a person photographed by the camera 15, and to perform face authentication of a person being the other party of the TV call.

The mobile phone 1 has a memory 35 in which a first database 35a and a second database 35b may be formed. Each entry of the first database 35a is a set of image data of a face (face image data) of a person of the first category. Each entry of the second database 35b is a set of face image data of a person of the second category.

The mobile phone 1 has a non-contact type IC chip 38 and a second antenna 39. The second antenna 39 may be either directly or indirectly (via another, not shown circuit element) linked to the IC chip 38. The IC chip 38 and the antenna 39 may conform, but not limited, to a standard of a non-contact type IC card which may send and receive radio signals to and from a reader/writer on a frequency of 13.56 MHz. The IC chip 38 may have an e-money function, i.e., may hold a set of data on a carried amount of money, and may be used for settling accounts, under control of the controller 27, by updating the data as the carried amount of money either increases or decreases.

An example of how to settle accounts by the e-money function will be described in a case of shopping at a store. Suppose that there is installed a reader/writer, a terminal of an accounting network, in the store. Suppose an amount of money to be settled is set in the reader/writer and the mobile phone 1 approaches the reader/writer close enough. The IC chip 38 then receives a signal sent from the reader/writer via the second antenna 39, including the information on the amount of money to be settled.

The IC chip 38 updates the data of the carried amount of money to be decreased by as much as the settled amount of money. The IC chip 38 gives a reply to the reader/writer via the second antenna 39, saying that the account has been settled. The reader/writer then reports to a host of the accounting network on the settlement and the settled amount of money. The host then continues a series of steps to be processed in the network.

An e-mail transceiver 27a, a first one of the main processes of the controller 27, will be explained as follows. The e-mail transceiver 27a may start working under control of the controller 27 if the user control 18 is operated to handle e-mails.

The e-mail transceiver 27a may arrange an outgoing e-mail including an e-mail address of an addressee, a title and a message, each of which may be formed by a plurality of numerals, letters and symbols entered on the user control 18. The e-mail transceiver 27a may provide the transmitter 23 with the outgoing e-mail to be sent to an e-mail server (not shown) of the network 6 via the duplexer 22, the first antenna 21 and a base station (not shown) of the network 6, under control of the controller 27.

The e-mail transceiver 27a may receive an incoming e-mail sent from the e-mail server via the base station, the first antenna 21, the duplexer 22 and the receiver 24, under control of the controller 27. The e-mail transceiver 27a may store the received e-mail either in the memory 35 or in another memory (not shown), and may once stop working.

The e-mail transceiver 27a may restart working under control of the controller 27 if the user control 18a is operated to do so. The e-mail transceiver 27a may provide the display 16 via the display inter-face 32 with a list of received e-mails stored in the memory 35 or else so that the list may be presented on the display 16. The e-mail transceiver 27a may select one of the stored e-mails as selected on the user control 18, and may provide the display 16 via the display inter-face 32 with the selected e-mail so that the selected e-mail may be presented on the display 16.

A browser 27b, a second one of the main processes of the controller 27, will be explained as follows. The browser 27b is a process to access a web site that may be linked through the network 6. The browser 27b may be activated and start accessing a web site if the user control 18 is operated to start web-browsing.

The browser 27b may form a set of data for accessing the web site including an address of the web site entered on the user control 18, and may provide the transmitter 23 with the formed set of data. The transmitter 23 generates an accessing signal based on the formed set of data and sends the accessing signal to the base station included in the network 6 via the duplexer 22 and the first antenna 21. That accessing signal then goes forward to the web site through the network 6.

The mobile phone 1 may be thereby linked to the web site, which may send back a responding signal including a set of responding information. The responding signal may reach the base station in a backward direction through the network 6, and then reach the mobile phone 1. The browser 27b may obtain the set of responding information via the first antenna 21, the duplexer 22 and the receiver 24. The browser 27b may provide the display 16 via the display interface 32 with the responding information to be presented.

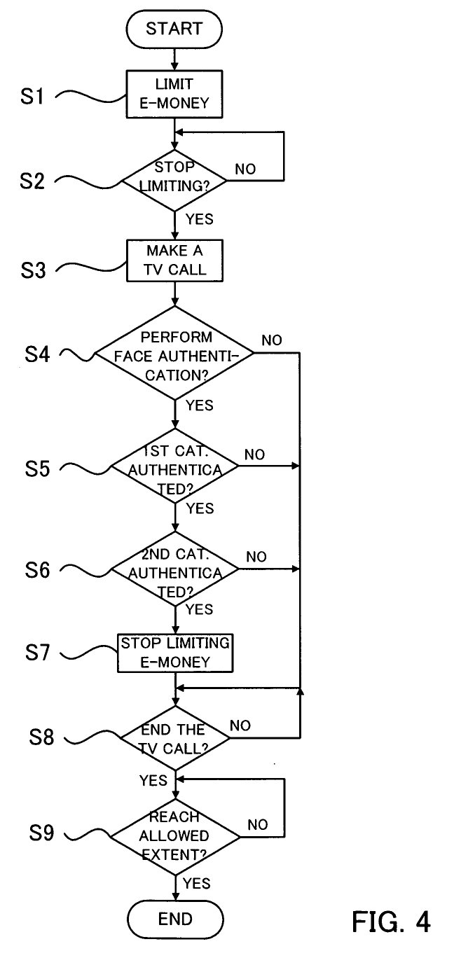

An e-money limiter 27c, a third one of the main processes of the controller 27, will be explained as follows. The e-money limiter 27c may limit the e-money function by limiting an operation of the IC chip 38 unless a set of predetermined requirements are satisfied, which will be described with reference to FIG. 4 later. The e-money limiter 27c may stop limiting the e-money function if the set of predetermined requirements are satisfied.

The e-money limiter 27c may deactivate the IC chip 38. The e-money limiter 27c may have the IC chip 38 give a reply to a reader/writer via the second antenna 39 saying that the e-money function is being ineffective. The limitation imposed on the e-money function may be, but not limited to, regarding if the use of the e-money function is allowed or not, how long the use is allowed, for what the use is allowed, and to what extent the use is allowed.

A face authenticator 27d, a fourth one of the main processes of the controller 27, will be explained as follows. The face authenticator 27d may obtain a set of face image data of a photographed person sent from the camera 15 to the controller 27 via the codec 30. The face authenticator 27d may detect an inclination of the face and may detect a location of each element of the face out of the face image data, may determine a location of each feature point (a center of an eye, an end of a lip, etc.), may measure a distance between one feature point and another feature point, and may consequently extract a feature value of the face image data of the photographed person.

The face authenticator 27d may compares the feature value of the photographed person with a feature value of a person of the first category registered in the first database 35a. The face authenticator 27d may detect a coincidence between the person photographed by the camera 15 and the registered person of the first category (limited function user) by such a known method of face authentication (refer to Akamatsu, e.g.).

During a TV call between the mobile phone 1 and the mobile phone 7, the mobile phone 1 may receive a signal carrying a plurality of digital data including a face image data of a person at the mobile phone 7 through the network 6. The signal is received by the receiver 24 via the first antenna 21 and the duplexer 22. The controller 27 may obtain the face image data of the person at the mobile phone 7.

The face authenticator 27d may extract a feature value of the face image data of the person at the mobile phone 7 by the method described above. The face authenticator 27d may compare the feature value of the person at the mobile phone 7 with a feature value of a person of the second category registered in the second database 35b. The face authenticator 27d may detect a coincidence between the person at the mobile phone 7 and the registered person of the second category (supervisor).

How the face authentication is done by the mobile phone 1 will be described with reference to FIG. 4, a flow chart of a process of the first embodiment. After the process starts (“START”), the e-money limiter 27c limits the e-money function by limiting the operation of the IC chip 38 (step “S1”). For limiting the operation, the e-money limiter 27c may deactivate the IC chip 38. For limiting the operation, the e-money limiter 27c may have the IC chip 38 give an ineffective reply.

The user control 18 is operated by an authenticated operator so that the e-money limiter 27c may limit the e-money function. The operator may be authenticated by a face. The operator may be authenticated by a password entered on the user control 18. The e-money function may be limited as a default without such operation or authentication.

The controller 27 waits for the user control 18 to be operated in a predetermined way to stop limiting the e-money function (“NO” of step “S2”). If the user control 18 is operated in that way (“YES” of step “S2”), the mobile phone 1 makes a TV call to the mobile phone 7 (step “S3”). The TV call may be either automatically made or manually made, i.e., by a series of operation on the user control 18. An order of the steps “S2” and “S3” may be reversed (i.e., the user control 18 is operated to stop limiting the e-money function after the TV call is made).

If the user control 18 is operated for performing face authentication (“YES” of step “S4”), the controller 27 has the face authenticator 27d perform face authentication of a person photographed by the camera 15. If the face authenticator 27d detects a coincidence between the photographed person and a registered person of the first category (“YES” of step “S5”), the controller 27 has the face authenticator 27d perform face authentication of a person at the mobile phone 7. If the face authenticator 27d detects a coincidence between the person at the mobile phone 7 and a registered person of the second category (“YES” of step “S6”), the controller 27 has the e-money limiter 27c stop limiting the operation of the IC chip 38 (step “S7”).

After the limitation is stopped, allowed is a certain extent of use, that may be an upper amount of e-money, may be an object of use (shopping at a particular store, e.g.), may be a period of time of use, and may be a combination of those. The controller 27 may be configured to stop limiting the e-money function only during the TV call. For the face authentication at the step “S6”, the face authenticator 27d may search for a registered person of the second category with reference to a phone number of the mobile phone 7, and may do so without reference to the phone number of the mobile phone 7.

The controller 27 waits for the user control 18 to be operated to end the TV call (“NO” of step “S8”). After the operation, the TV call is ended (“YES” of step “S8”). The e-money limiter 27c waits for the allowed extent of use to be reached (“NO” of step “S9”). If the e-money limiter 27c finds out that the allowed extent of use is reached, the controller 27 ends the flow of the process (“YES” of step “S9”). In a case where the controller 27 is configured to stop limiting the e-money function only during the TV call, an order of the steps “S8” and “S9” should be reversed.

Before the user control 18 is operated for performing face authentication (“NO” of step “S4”), the controller 27 keeps limiting the e-money function and waits for the user control 18 to be operated to end the TV call. Unless the face authenticator 27d detects a coincidence between the photographed person and a registered person of the first category (“NO” of step “S5”), the controller 27 keeps limiting the e-money function and waits for the user control 18 to be operated to end the TV call. Unless the face authenticator 27d detects a coincidence between the person at the mobile phone 7 and a registered person of the second category (“NO” of step “S6”), the controller 27 keeps limiting the e-money function and waits for the user control 18 to be operated to end the TV call.

An order of the steps “S5” and “S6” may be reversed. The first embodiment of the present invention may be applied not only to an e-money function but also to another function that may be used through the browser 27b and may be limited in a certain sense, e.g., settling accounts for on-line dealings (shopping, banking, etc.), a request in an on-line administrative process and so forth. The first embodiment of the present invention may be applied to no less than two functions.

According to the first embodiment described above, a communication apparatus may improve security for a right person using a particular function by stopping limiting the function based on double authentication of a limited function user and a supervisor.

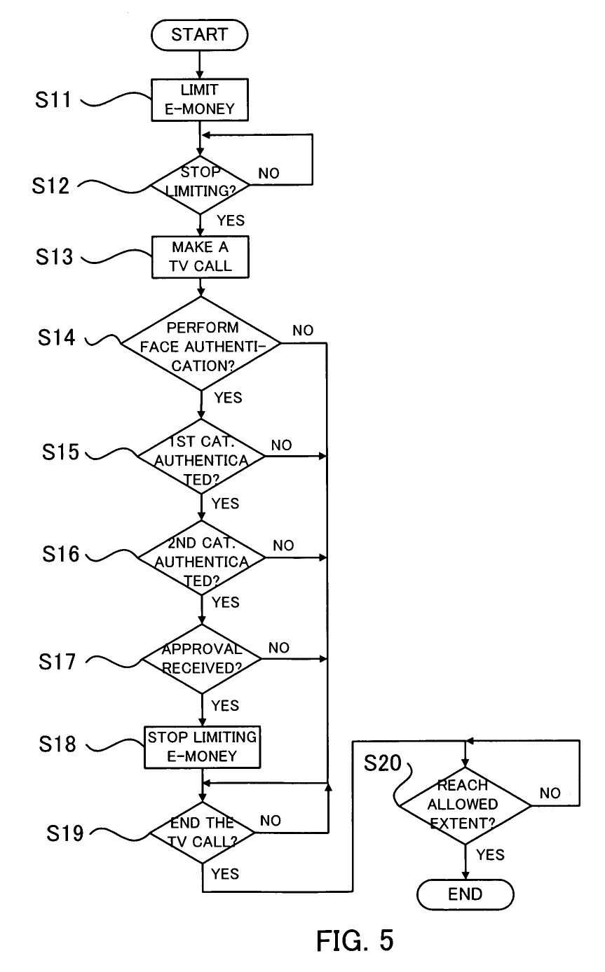

A second embodiment of the present invention will be described with reference to FIG. 5. As a communication apparatus of the second embodiment is a same as the mobile phone 1 of the first embodiment, FIGS. 1-3 are also referred to. FIG. 5 is a flow chart of a process of the second embodiment.

After the process starts (“START”) in FIG. 5, each of a series of steps “S11 ”-“S16” is a same as the corresponding one of the steps “S1”-“S6” in FIG. 4, and its explanation is omitted. An order of the steps “S12” and “S13” may be reversed. An order of the steps “S15” and “S16” may be reversed.

If the face authenticator 27d detects a coincidence between a person photographed by the camera 15 and a registered person of the first category (“YES” of step “S15”) and a coincidence between a person at the mobile phone 7 and a registered person of the second category (“YES” of step “S16”), the controller 27 waits for an approval to stop limiting the e-money function to be sent from the mobile phone 7. The approval is expressed by a specific signal generated by a series of key operation on the mobile phone 7. The specific signal is multiplexed with a voice signal during the TV call and sent from the mobile phone 7. The controller 27 may separate and detect the specific signal out of the voice signal.

Upon detecting the specific signal sent from the mobile phone 7 and receiving the approval (“YES” of step “S17”), the controller 27 has the e-money limiter 27c stop limiting the operation of the IC chip 38 (step “S18”). Each of a following series of steps “S19”, “S20” and “END” is a same as the corresponding one of the steps “S8”, “S9” and “END” in FIG. 4, respectively, and its explanation is omitted.

Before the user control 18 is operated for performing face authentication (“NO” of step “S14”), the controller 27 keeps limiting the e-money function and waits for the user control 18 to be operated to end the TV call. Unless the face authenticator 27d detects a coincidence between the photographed person and a registered person of the first category (“NO” of step “S15”), the controller 27 keeps limiting the e-money function and waits for the user control 18 to be operated to end the TV call.

Unless the face authenticator 27d detects a coincidence between the person at the mobile phone 7 and a registered person of the second category (“NO” of step “S16”), the controller 27 keeps limiting the e-money function and waits for the user control 18 to be operated to end the TV call. Before receiving the approval (“NO” of step “S17”), the controller 27 keeps limiting the e-money function and waits for the user control 18 to be operated to end the TV call.

In a case where the controller 27 is configured to stop limiting the e-money function only during the TV call, an order of the steps “S19” and “S20” should be reversed. The second embodiment of the present invention may be applied to another function that may be limited in a certain sense. The second embodiment of the present invention may be applied to no less than two functions, as the first embodiment. The specific signal expressing the approval may be sent from the mobile phone 7 in a way other than being multiplexed with the voice signal.

According to the second embodiment described above, a communication apparatus may improve security as in the first embodiment, and may further improve the security by sending an approval from a supervisor to a limited function user.

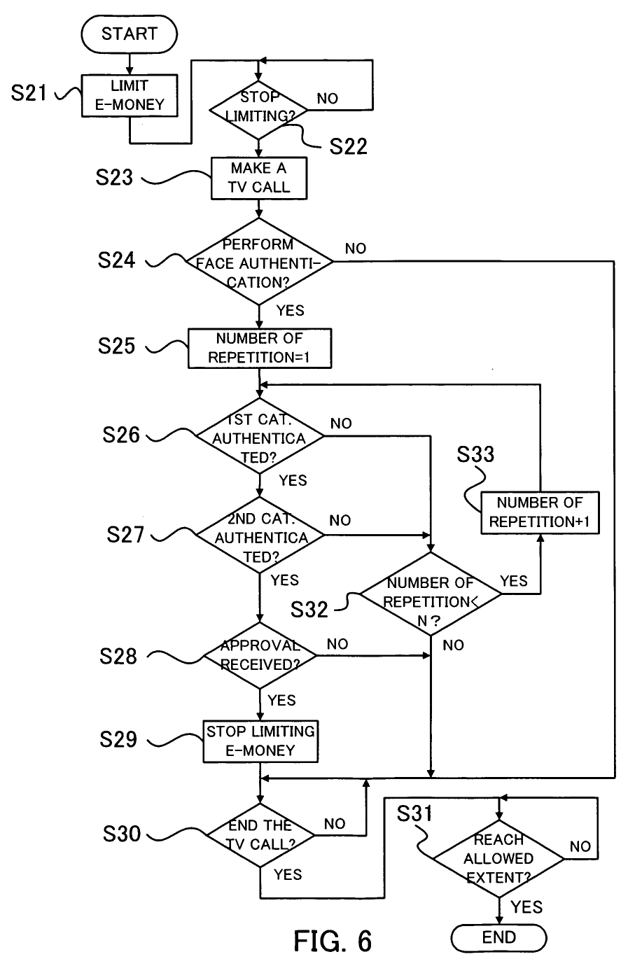

A third embodiment of the present invention will be described with reference to FIG. 6. As a communication apparatus of the third embodiment is a same as the mobile phone 1 of the first embodiment, FIGS. 1-3 are also referred to. FIG. 6 is a flow chart of a process of the third embodiment.

After the process starts (“START”) In FIG. 6, each of a series of steps “S21”-“S24” is a same as the corresponding one of the steps “S11”-“S14” in FIG. 5, and its explanation is omitted. An order of the steps “S22” and “S23” may be reversed.

If the user control 18 is operated for performing face authentication (“YES” of step “S24”), the controller 27 sets a number of repetitive authentication to one (step “S25”). Each of a following series of steps “S26” through “S31” (“YES”) and “END” is a same as the corresponding one of the steps “S14” through “S20” (“YES”) and “END” in FIG. 5, respectively, and its explanation is omitted. An order of the steps “S26” and “S27” may be reversed.

Unless the face authenticator 27d detects a coincidence between a person photographed by the camera 15 and a registered person of the first category (“NO” of step “S26”), the controller 27 finds out if the number of repetitive of authentication reaches a predetermined upper value N.

If the number of repetitive authentication is less than N (“YES”of step “S32”), the controller 27 adds one to the number (step “S33”), and goes back to the step “S26” to repeat performing the face authentication. As a probability of successful authentication may be influenced and lowered by, e.g., a condition of taking pictures even though the person to be authenticated has been registered in one of the first category and the second category, such a repetition of no greater than N times may raise the probability to a certain degree.

If the number of repetitive authentication is no less than N (“NO” of step “S32”), the controller 27 keeps limiting the e-money function and waits for the user control 18 to be operated to end the TV call. Before the user control 18 is operated for performing face authentication (“NO” of step “S24”), the controller 27 keeps limiting the e-money function and waits for the user control 18 to be operated to end the TV call. Before receiving the approval (“NO” of step “S28”), the controller 27 keeps limiting the e-money function and waits for the user control 18 to be operated to end the TV call.

In a case where the controller 27 is configured to stop limiting the e-money function only during the TV call, an order of the steps “S30” and “S31” should be reversed. The third embodiment of the present invention may be applied to another function that may be limited in a certain sense. The third embodiment of the present invention may be applied to no less than two functions, as the first embodiment and as the second embodiment. The specific signal expressing the approval may be sent from the mobile phone 7 in a way other than being multiplexed with the voice signal, as in the second embodiment.

The controller 27 may be configured to repeat performing the face authentication before a certain period of time passes since the user control 18 is operated to perform the face authentication. In a case where no approval from the mobile phone 7 is required to stop limiting a particular function as in the first embodiment, the controller 27 may be configured to repeat performing the face authentication before the number of repetitive authentication reaches N, and the controller 27 may be configured to repeat performing the face authentication before a certain period of time passes since the user control 18 is operated to perform the face authentication.

According to the third embodiment of the present invention described above, a communication apparatus may further raise a probability of successful authentication by repeating the authentication process to a certain extent.

In the first through the third embodiments described above, a way of authentication may not be limited to face authentication, but may depend on other kinds of living body information like a fingerprint, an iris, a voiceprint, and may depend on a password formed by a permutation of numerals, letters and symbols. A way of authenticating a limited function user may be different from a way of authenticating a supervisor. The present invention may be applied to a communication apparatus other than a mobile phone capable of obtaining and receiving information for personal authentication with no regard if it is either wired or wireless.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A communication apparatus capable of authenticating a plurality of people, comprising:
an input device configured to obtain a first set of data for identifying a first person of the people;
a receiver configured to receive a second set of data for identifying a second person of the people;
a memory configured to store a plurality of data for identifying at least two of the people;
a controller coupled to the input device, the receiver and the memory, the controller being configured to limit a particular function of the communication apparatus, to compare the first set of data and the stored data, to compare the second set of data and the stored data, and to stop limiting the particular function upon finding out that one and another of the two people identified by the stored data coincide with the first person and the second person, respectively.

2. The communication apparatus of claim 1, wherein the controller is configured to stop limiting the particular function upon finding out that one and another of the two people identified by the stored data coincide with the first person and the second person, respectively, and upon receiving an approval to stop limiting the particular function.

3. The communication apparatus of claim 1 further comprising a non-contact type IC chip usable for the particular function, wherein the controller is configured to stop limiting an operation of the IC chip upon finding out that one and another of the two people identified by the stored data coincide with the first person and the second person, respectively.

4. A communication apparatus capable of authenticating a plurality of people, comprising:
a non-contact type IC chip applicable to a particular use;
an input device configured to obtain a first set of image data for identifying a first person of the people;
a transceiver configured to send and receive a plurality of voices and a plurality of images for a TV call;
a memory configured to store a plurality of image data for identifying at least two of the people;
a limiter configured to limit an operation of the IC chip;
a controller coupled to the non-contact type IC chip, the input device, the transceiver, the memory and the limiter,
the controller being configured, if operated to stop limiting the operation of the IC chip in a predetermined way, to activate the transceiver, to make a TV call, to compare the first set of image data and the stored image data, to compare a second set of image data for identifying a second person of the people received by the transceiver during the TV call and the stored image data, and to have the limiter stop limiting the operation of the IC chip upon finding out that one and another of the two people identified by the stored image data coincide with the first person and the second person, respectively.

5. A communication apparatus capable of authenticating a plurality of people, comprising:
a non-contact type IC chip applicable to a particular use;
an input device configured to obtain a first set of image data for identifying a first person of the people;
a transceiver configured to send and receive a plurality of voices and a plurality of images for a TV call;
a memory configured to store a plurality of image data for identifying at least two of the people;
a limiter configured to limit an operation of the IC chip;
a controller coupled to the non-contact type IC chip, the input device, the transceiver, the memory and the limiter,
the controller being configured, if operated to stop limiting the operation of the IC chip in a predetermined way during a TV call, to compare the first set of image data and the stored image data, to compare the first set of image data and the stored image data, to compare a second set of image data for identifying a second person of the people received by the transceiver during the TV call and the stored image data, and to stop limiting the operation of the IC chip upon finding out that one and another of the two people identified by the stored image data coincide with the first person and the second person, respectively.

6. The communication apparatus of claim 5, wherein the limiter is configured to limit the operation of the IC chip after the TV call is ended.

7. The communication apparatus of claim 4, wherein the limiter is configured to limit the operation of the IC chip having been applied to the particular use to a preset allowable extent.

8. The communication apparatus of claim 5, wherein the limiter is configured to limit the operation of the IC chip having been applied to the particular use to a preset allowable extent.

9. The communication apparatus of claim 4, wherein the limiter is configured to limit the operation of the IC chip having been applied a preset number of times.

10. The communication apparatus of claim 5, wherein the limiter is configured to limit the operation of the IC chip having been applied a preset number of times.

11. The communication apparatus of claim 4, wherein the limiter limits the operation of the IC chip by deactivating the IC chip.

12. The communication apparatus of claim 5, wherein the limiter limits the operation of the IC chip by deactivating the IC chip.

13. The communication apparatus of claim 4, wherein the limiter limits the operation of the IC chip by having the IC chip give an ineffective reply.

14. The communication apparatus of claim 5, wherein the limiter limits the operation of the IC chip by having the IC chip give an ineffective reply.
